(19) United States
(12) Patent Application Publication
(10) Pub. No.: US 2003/0216996 A1
(43) Pub. Date: Nov. 20, 2003

(54) Methods and systems for providing financial payment services

(75) Inventors: Bradley R. Cummings, Richmond, VA (US); Eric D. Fox, Richmond, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/143,800

(22) Filed: May 14, 2002

(51) Int. Cl. G06F 17/60

(52) U.S. Cl. 705/39

(57) ABSTRACT

Methods and systems are disclosed that allow a third party system to bypass a financial interchange network to make payments to a merchant on behalf of a customer. The payment to the merchant may be based on a financial account associated with the customer. The third party system may be adapted to receive a payment request from the customer that identifiers the merchant, a payment amount, and a financial account provided by a financial account provider. The third party system may provide the information included in the payment request to the financial account provider through a communication path or channel that bypasses the interchange network. The financial account provider may charge the payment amount to the financial account of the user and/or transfer funds equal to at least the payment amount to the third party system. Following authorization and/or receipt of the transferred funds, the third party system may make a payment to the merchant equal to the payment amount included in the payment request.

### BACKGROUND OF THE INVENTION

1. Field of the Invention

The present invention generally relates to financial payment services, and more particularly, to methods and systems for providing financial payment services that bypass a financial interchange network.

2. Background and Material Information

Financial account management has become an increasingly important issue for the average consumer. The increase in the popularity of financial services, such as credit cards, automatic debit payment processes, customized checking, savings and investment accounts, coupled with the onset of the Internet and electronic commerce, have forced many consumers to become personal financial managers for their different types of accounts. Financial services can provide consumers the versatility and freedom to control their assets and credit. Along with this freedom, however, comes the responsibility of managing a wide range of accounts in order to ensure payments are not late, balances are not exceeded, and purchases/investments are legitimate.

Consumers with many different financial accounts, such as credit card accounts, utility accounts, mortgage accounts, etc., may have trouble keeping current with account balances, payments and other transactions. The consequences of mis-management may result in penalties being assessed against the consumer by the providing the accounts. For example, penalties may be associated with late payments or balance thresholds that are exceeded by a consumer.

In order to help consumers manage their financial accounts, on-line account management services have been created. These services allow consumers to enroll with a financial service that collects and manages account information for the consumer. Consumers may enroll by providing information associated with the financial accounts that they wish to have managed. In turn, these financial service providers act as a trusted intermediary by accessing information provided by the institutions governing the accounts associated with the consumers. For instance, a trusted intermediary may collect account information from each institution and combine the information into an aggregated document reflecting balance information associated with accounts the consumers selected to have monitored. The document may then be sent to the consumers for display through, for example, a browser application running at a client site where the consumer is located.

In addition to providing documentation regarding account information, trusted intermediaries may also provide third party payment services for a consumer. For example, a consumer may authorize a trusted intermediary to make payments on behalf of the consumer to accounts held with various institutions or merchants, such as a mortgage company or a utility company. In some instances, authorized payments made by a trusted intermediary can be associated with a credit card account held by the consumer. For instance, a trusted intermediary may be authorized to provide payments to a merchant using the credit card account held by the consumer. Alternatively, a merchant may allow credit card account payments directly from the consumer. In either situation, the processing of such payments typically involves the services of a financial interchange network.

An interchange network is an environment associated with or provided by a financial institution, such as MasterCard or Visa. Generally, interchange networks provide financial services associated with credit card products. For example, an interchange network may be used by merchants or service providers to process credit card transactions with customers. At any moment, the interchange network may receive a plurality of these credit card transactions from a plurality of merchants and/or service providers. Each transaction may be processed by the interchange network to determine a financial account provider associated with credit card account for purposes of further processing, including authorization and billing.

Although the services performed by interchange networks allow merchants and financial account providers to provide efficient and automated transactions for customers, these services are provided at a cost. That is, entities that use interchange networks are typically charged fees for the transactions that are processed through the network. For instance, when a trusted intermediary processes a credit card payment for a consumer using an interchange network, a fee is charged to the trusted intermediary. This fee is typically passed down to the consumer in one form or another, such as increased fees charged by the intermediary for performing its respective services for the consumer.

Although there are benefits to allowing consumers to automatically make credit card payments to merchants and other entities, the costs associated with incorporating an interchange network may prevent potential consumers from using automatic payment services. Further, some merchants may not permit or accept payments through an interchange network, such as credit card payments. Accordingly, there is a need for providing automatic payment services for consumers that avoid the fees customarily associated with interchange network services.

### SUMMARY OF THE INVENTION

Embodiments of the present invention enable a financial account provider to offer payment services to consumers that avoid the services of an interchange network. Further, embodiments of the invention allow consumers to use credit card accounts to make payments to merchants who may not accept credit card payments.

In an embodiment of the present invention, an environment may be configured to perform a process for providing financial services that bypasses a financial interchange network. The process may include providing, from a third party system to a financial account provider, a funds request that identifies a payment amount and merchant designated by a user, and a financial account held by the user with the financial account provider, whereby the third party system bypasses the interchange network to provide the funds request. Based on the authorization of the funds request, the payment amount may be charged to the financial account. Further, funds that include at least the payment amount may be transferred to the third party system for payment to the merchant.

Additional features and embodiments of the invention will be set forth in part in the description which follows, and in part will be obvious from the description, or may be learned by practice of the embodiments of the invention. It is to be understood that both the foregoing general summary and the following detailed description are exemplary and explanatory only and are not restrictive of the embodiments of the invention, as claimed. Further features and/or variations may be provided in addition to those set forth herein. For example, embodiments of the invention may be directed to various combinations and sub-combinations of the disclosed features and/or combinations and sub-combinations of several further features disclosed below in the detailed description.

### BRIEF DESCRIPTION OF THE DRAWINGS

The accompanying drawings, which are incorporated in and constitute a part of this specification, illustrate various embodiments of the present invention, and, together with the description, serve to explain features and aspects of the invention. In the drawings:

FIG. 1 illustrates an exemplary system environment, consistent with embodiments of the present invention;

FIG. 2 shows a block diagram of an exemplary financial account provider, consistent with embodiments of the present invention;

FIG. 3 is a flowchart of an exemplary payment process, consistent with embodiments of the present invention; and

FIG. 4 is a flowchart of another exemplary payment process, consistent with embodiments of the present invention.

### DETAILED DESCRIPTION

Embodiments of the present invention provide financial services to a user or consumer that bypass the services of a financial interchange network Embodiments of the invention also permit users to use credit card accounts to make payments to accounts that do not accept credit card payments. The term “user” and “customer” can be used interchangeably in the following description without departing from the scope of the embodiments of the present invention. For example, a user may or may not be a customer of selected entities consistent with certain aspects related to the invention.

According to an embodiment of the invention, a user may enlist the services of a third party system to make automatic payments to one or more entities, such as merchants or service providers. The entities may maintain accounts associated with the user that may have outstanding balances for goods and/or services purchased by the user. In one aspect of the invention, the third party system may receive a payment request from the user identifying a merchant or other entity that the user is obligated to provide a payment and the amount of the payment. The payment request may also identify a financial account provider that maintains a financial account for the user, such as a credit card, and an identifier of the account. The third party system may locate the financial account provider based on the information in the payment request and establish a communication session directly with the provider. The information in the payment request may then be provided to the financial account provider as a funds request using the communication session, thereby bypassing the services of an interchange network.

Moreover, in accordance with another aspect of the invention, the financial account provider may authorize the funds request to verify the financial account and payment amount requested by the user. If authorized, the financial account provider may charge the payment amount to the user's financial account. Also, financial account provider may prepare and transfer funds to the third party system that are at least equal to the payment amount charged to the account. Third party system may receive the funds, verify the amount against the payment amount requested by the user, and provide payment to the merchant or entity for the user's account indicated in the payment request.

Embodiments of the present invention may be implemented in various environments. Such environments and related applications may be specially constructed for performing the various processes and operations of the embodiments of the invention or they may include a general purpose computer or computing platform selectively activated or reconfigured by program code to provide the necessary functionality. The processes disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

Embodiments of the present invention also relate to computer readable media that include program instructions or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

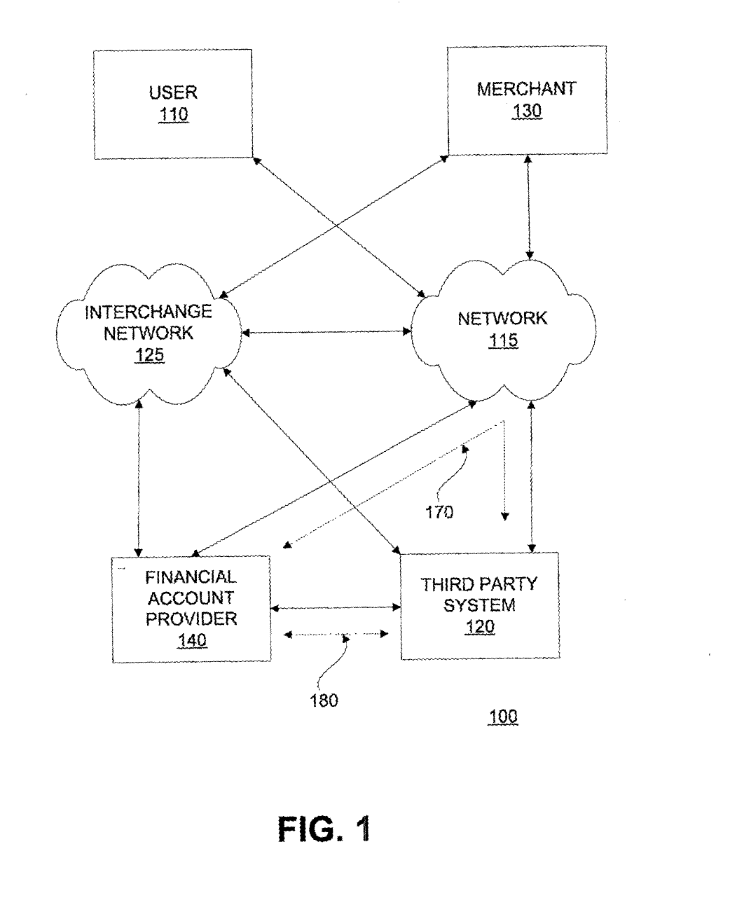

FIG. 1 illustrates an exemplary system environment 100, consistent with embodiments of the present invention. As illustrated in FIG. 1, environment 100 includes a user 110, a network 115, a third party system 120, an interchange network 125, a merchant 130, and a financial account provider 140.

User 110 may include a computing system, such as a desktop computer, workstation, laptop, personal digital assistant or any other similar client side computing system known in the art, that is associated with an individual, group of individuals, a business entity or entities. User 110 may be associated with a customer of financial account provider 140, merchant 130, and/or third party system 120. User 110 may be equipped with browser software such as Netscape Navigator, Microsoft Internet Explorer, or any other known browser software that enable user 110 to access and communicate with remote entities attached to network 115. User 110 may also include other communication systems and/or devices, such as wired and wireless telephony devices, that enable user 110 to communicate with remote entities, such as third party system 120, merchant 130, and financial account provider. Although FIG. 1 shows only a single user 110, one skilled in the art will recognize that additional users 110 may be implemented in computing environment 100 without departing from the scope of the invention.

Network 115 may include any type of network that facilitates communication and data transfer between user 110, interchange network 125, third party system 120, financial account provider 140, and merchant 130. Network 115 may be a Local Area Network (LAN), a Wide Area Network (WAN), such as the Internet, and may be single network or combination of networks. Further, network 115 may reflect a single type of network, a combination of different types of networks, such as the Internet and public exchange networks for wired and/or wireless communications. One skilled in the art will recognize that network 115 is not limited to the above examples and that computing environment 100 may implement any type of network that allows the entities (and other not shown) included in FIG. 1 to exchange data.

Third party system 120 may include a computer system, such as a workstation, desktop computer, server, mainframe, or any other type of computer system that includes known computer system components for processing data and communicating with network 115, interchange network 125, and/or the other remote entities. In one embodiment of the present invention, third party system 120 may be associated with a business entity that provides on-line payment services for a customers. For example, third party system 120 may manage financial accounts for a customer, such as user 110, and make payments to merchants associated with the accounts in exchange for fees paid by the customer. Alternatively, third party server 120 may manage financial accounts associated with a customer based on a business relationship with financial account provider 140. For instance, in one embodiment of the invention, user 110 may hold a credit card account with a financial account provider, such as provider 140. Third party system 120 may perform financial services for the account provider and customer, such as making payments to entities that maintain an account with the customer based on directives provided by the financial account provider. Alternatively, third party system 120 may be associated with financial account provider 140. That is, the services performed by third party system 120 may be included in or provided by financial account provider 140. One skilled in the art will realize that the configuration of FIG. 1 is exemplary, and that any combination of entities, such as third party system 120 and financial account provider 140 may be incorporated without departing from the scope of the present invention.

Interchange network 125 may include an environment consistent with known interchange networks. For example, interchange network 125 may include a plurality of processing modules and communication links associated with financial institutions, such as Visa or Master Card, that perform financial services associated with financial account products, such as credit cards. Interchange network 125 may receive from remote entities one or more financial transactions associated with purchases of goods and/or services using a financial account, such as a credit card. Network 125 may filter the transactions based on an identity of a financial account provider (e.g., provider 140) associated with the financial account corresponding to each transaction.

The filtered transactions may then be provided to the appropriate financial account providers. In one embodiment of the invention, interchange network 125 may charge fees to the remote entities that provide the financial transaction and/or to the financial account providers identified in the transactions. One skilled in the art will realize that the services performed by interchange network 125 are not limited to the above examples. That is, any or all of the services performed by interchange networks known in the art may be incorporated by interchange network 125 without departing from the scope of the present invention.

Merchant 130 may include a computing system, such as a workstation, desktop computer, server, mainframe, or any other type of computer system that includes known computer system components for processing data and communicating with network 115 and/or the other remote entities. Merchant 130 may be associated with an individual, group of individuals, a business entity or entities that provide goods and/or services to customers. Merchant 130 may charge fees for the goods and/or services they provide and may maintain financial accounts with customers that owe debts based on these fees. For example, merchant 130 may be associated with a utility company that provides utility services for a customer, such as user 110. Further, the utility company may maintain an account for user 110 to manage fees that are charged for the utility service used by user 110.

Merchant 130 may include various infrastructures to handle the payment of fees from remote sources, such as user 110. For example, merchant 130 may include a telephony-based communications infrastructure that allows a customer to authorize payments for an account associated with the customer. The authorized payments may be processed from a financial account designated by the customer, such as a checking account, a savings account, a debit account and a credit card account. Merchant 130 may process the telephonic payments automatically (e.g., automated response processes), manually (e.g., customer service representative), or a combination of automatic and manual processing (e.g., customer service representative may authenticate the customer and allow a processing script to handle the transferring of funds).

In addition, or alternatively, to a telephony-based communications infrastructure, merchant 130 may include a standard mail based infrastructure for processing payments. For example, merchant 130 may process payments from remote sources that have been provided through traditionally mail services, such as the United States Postal Service. Merchant 130 may process these types of payments automatically, manually, or a combination of both.

Additionally, or alternatively, merchant 130 may include a network-based communications infrastructure that processes payments from remote sources, such as user 110. For example, merchant 130 may include front and backend servers, including web servers, that allow a customer to make automatic payments over network 120. For instance, merchant 130 may include computing system components that receive authorization data and/or fund transfer information from a remote source, such as user 110, financial account provider 140, and/or third party system 120. Further, merchant 130 may maintain web sites that provide information and services to remote entities through network 115. For example, a remote entity, such as user 110, third party system 120, or financial account provider 140, may access the web site to obtain information associated with goods and/or services provided by merchant 130. Also, the merchant's web site may provide information associated with one or more accounts corresponding to its customers, such as user 110.

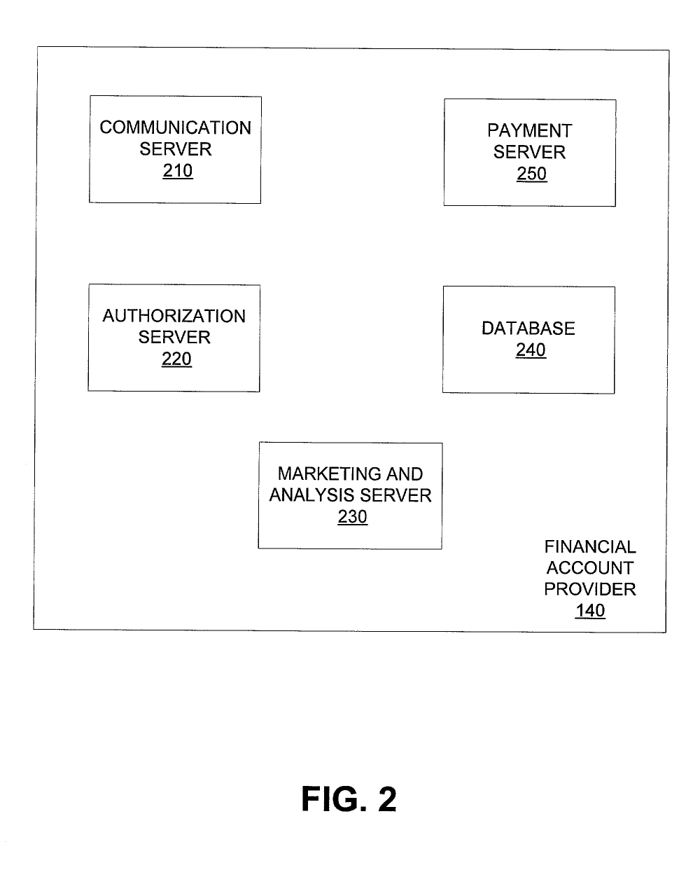

Financial account provider 140 may include a computing system, such as a workstation, desktop computer, server, mainframe, or any other type of computer system that includes known computer system components for processing data and communicating with network 115 and/or other remote entities. Provider 140 may be associated with a business entity that provides financial accounts to customers, such as user 110. The financial accounts may include, but are not limited to, credit card accounts, checking accounts, saving accounts, or any other type of financial account from which a customer may use to pay for goods and/or services. As with merchant 130, financial account provider 140 may include various types of infrastructures to handle communications with remote entities, including, but not limited to, telephony-based communication, standard mail communication, and network based communication infrastructures. In one aspect of the invention, financial account provider 140 may include processing components that perform functions consistent with certain features related to the invention. For example, FIG. 2 shows a block diagram of an exemplary financial account provider 140, consistent with embodiments of the present invention.

As illustrated in FIG. 2, financial account provider 140 may be implemented with a number components. These components may be adapted to communicate and/or exchange data with one another. Consistent with an embodiment of the invention, the components of financial account provider 140 may include a communication server 210 that handles communications to and from network 115 or directly from remote sources, such as third party system 120, user 110, and merchant 130. Further, provider 140 may include an authorization server 220 for performing, among other things, authorization and authentication functions consistent with embodiments of the present invention. Provider 140 may also include a marketing and analysis server 230 for preparing payment transactions for processing to a corresponding financial account. Also, provider 140 may include a database 240 that stores account information for accounts of each user 110. Such account information may include information concerning recent transactions, outstanding and available balances, overdue payments (if any), and/or account status. Alternatively, or additionally, database 240 may include a record of transactions that occur between third party system 120 and financial account provider 140. Database 240 may be implemented as a centralized database or a distributed database system. Database 240 may also be adapted with high or massive storage capabilities to store large quantities of transaction information, as well as other types of information.

Financial account provider 140 may also include a payment server 250.

Payment server 250 may handle financial account functions, consistent with embodiments of the present invention. For example, payment server 250 may charge a customer's account based on purchases made by the customer using a credit card provided by financial account provider 140. Further, payment server 250 may make payments to third party system 120 using various fund transfer techniques, such as Automated Clearing House (ACH) transfers and/or other forms of electronic fund transfers.

As indicated above, user 110 may make automatic payments to remote entities using network 115 and/or interchange network 125. In certain situations, however, an entity, such as merchant 130, may not allow a customer to make automated payments using certain types of financial accounts, such as a credit card account. Alternatively, merchant 130 may charge extra fees to user 110 if a payment is directly made using interchange network 125. Further, additional fees may be charged to user 110 if other entities facilitate payments to merchant 130 using interchange network 125. Accordingly, embodiments of the present invention enable a user 110 to authorize third party system 120 to make payments to merchant 130 without the use of interchange network 125.

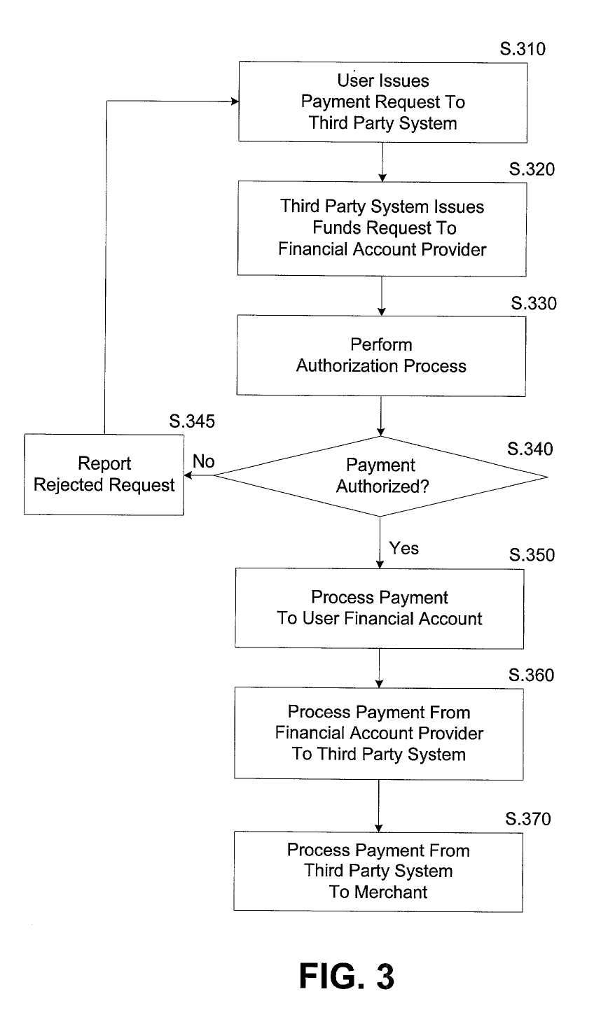

FIG. 3 shows a flow chart of an exemplary payment process, consistent with embodiments of the present invention. As shown in FIG. 3, the payment process may begin when user 110 issues a payment request to third party system 120 (step S.310). In one aspect of the present invention, the request may include one or more identifiers associated with one or more accounts. Each account may be associated with an entity or merchant, such as merchant 130. For example, a payment request may include an identifier for an account held with a utility company. Alternatively, or additionally, the payment request may include an identifier associated with a merchant, such as a vendor number, and a payment amount that user 110 is interested in making to the identified merchant. Additionally, the payment request may include an identifier reflecting a financial account held by user 110 and an identifier reflecting a financial account provider that provides the financial account, such as financial account provider 140.

Consistent with embodiments of the invention, the payment request may be provided to third party system 120 using various communication techniques. For example, user 110 may execute web browser software, such as Microsoft Internet Explorer to access a web site maintained by third party system 120 through network 115. Using the browser software, user 115 may provide the identifiers included in a payment request on a web page and submit the information to third party system 120 over network 115. For instance, user 115 may provide the payment request by entering data in fields included on a web page maintained by third party system 120 and submitting the entered information over network 125. Alternatively, user 115 may contact third party system 120 using wired or wireless communication networks. For example, third party system 120 may allow an automated or human based service to collect the identifiers included in the payment request from user 110 using a telephone device. Although certain aspects of the invention are described with reference to a single user 110 that provides a payment request, third party system 120 may receive a plurality of payment requests from one user or a plurality of different users, consistent with embodiments of the present invention.

The information associated with the payment request may be provided in separate payment requests. For example, user 110 may provide separate requests to third party system 120, whereby each request may include a separate identifier. That is, user 110 may provide the identifier of the merchant 130 to third party system 120 in one request and the identifier of the financial account of the user maintained by provider 140 in another request. Further, an identifier included in a payment request may identify more than one piece of information. For instance, a single identifier may be associated with a merchant and a merchant account corresponding to the user 110. Alternatively, a single identifier may reflect both financial account provider 140 and a financial account associated with user 110.

After third party system 120 has received the payment request from user 110, a communication session may be established between financial account provider 140 and third party system 120. This session may be created using a communication path that bypasses interchange network 125. The communication path may be a direct path from third party system 120 to provider 140. Alternatively, the communication path may be a path that uses network 115 to facilitate the exchange of information between third party system 120 and provider 140. For example, as shown in FIG. 1, third party system 120 may create communication session 170 that allows information to be exchanged with financial account provider 140 in a secured fashion through network 115. Session 170 may include the services of intermediary communication nodes associated with network 115, such as routers, repeaters, servers, and any other type of communication device that may facilitate communications between provider 140 and third party system 120. Alternatively, third party system 120 may establish a communication session 180 that allows direct access and secured communications with provider 140. Session 180 may be facilitated by a direct communication path that may be dedicated to the exchange of information between provider 140 and third party system 120 without the services of a network 115 or interchange network 125. For example, session 180 may be facilitated by a private data link, LAN, or any other type of communication path that may be established between provider 140 and third party system 120.

Once the communication session is established, third party system 120 may provide a funds request to financial account provider 140 (step S.320). The funds request provided by third party system 120 may be associated with any type of financial transaction corresponding to provider 140. For example, the funds request may include the identifier information reflecting the payment amount and financial account included in the payment request provided by user 110 to third party system 120. For example, the funds request may designate a savings account, checking account, credit card account, line of credit account, or any other type of financial account associated with user 110 and provided by financial account provider 140.

In accordance with an embodiment of the present invention, third party system 120 may create a batch file of fund requests based on a plurality of payment requests received from user 110 and/or a plurality of other users. The batch file may be provided as a single funds request from third party system 120 to provider 140 and may be provided in periodic intervals, such as hourly, daily, weekly, monthly, etc. Alternatively, third party system 120 may be configured to provide a single funds request based on a single payment request received from a user, such as user 110.

Consistent with embodiments of the invention, the funds request may be provided from third party system 120 to communication server 210. Alternatively, communication server 210 may be configured to pull the funds request from third party server 120. The manner by which the funds request is provided (or received) by financial account provider 140 may vary, without departing from the scope of the embodiments of the present invention.

In accordance with an embodiment of the invention, communication server 210 may forward the funds request from third party system 120 to authorization server 220 (see FIGS. 1 and 2). Once received, authorization server 220 may determine the type of funds request (e.g., batch or single) provided by communication server 210. In the event the funds request is a batch request, authorization server 220 may filter the individual fund requests that form the batch request based on the corresponding financial account identifiers. This way, financial account provider 140 may process each funds request based on the appropriate financial account information. Alternatively, authorization server 220 may ensure the integrity of a batch request before processing individual authorization transactions If the funds request is a single request, authorization server 220 may bypass the above described filtering process.

Once a financial account is identified based on the identifier information included in the funds request, authorization server 220 may perform an authorization process (step S. 330). During the authorization process, authorization server 220 may determine whether the funds request is authorized based on predetermined criteria, such as a status of the financial account associated with user 110. For this purpose, the identity of the user may also be indicated in the funds request. In one aspect of the present invention, the status of the financial account may be associated with account balance, financial transaction history, user credit level changes (e.g., loss of employment), and any other type of information that financial account provider may determine is appropriate to authorize the funds request. For example, authorization server 220 may determine whether an available balance associated with the financial account allows for the requested amount to be charged to the financial account. That is, a funds request may be denied if user 110 requested a payment amount of $200 when the user's financial account only has an available balance of $100. Alternatively, authorization server 220 may determine that the financial account associated with user 110 is not in good standing (e.g., consistent late payments, past due amounts, etc.) and deny the funds request accordingly. Further, financial account provider 140 may reject a funds request if it determines that an invalid account identifier is associated with user 110 indicated in the funds request. For example, if the funds request includes a account number that does not correspond to user 110, the request may be denied. Further, provider 140 may allow multiple financial accounts to be analyzed before denying authorization of a funds request. For example, provider 140 may offer user 110 an overdraft protection plan where a secondary account is provided to compensate for insufficient funds associated with a primary account. Thus, if provider 140 determines that the user's primary account has insufficient funds associated with the payment amount in the funds request, provider 140 may determine whether the secondary account includes sufficient funds to compensate for the insufficient funds. Financial account provider 140 may be implemented with a variety of authorization conditions to determine whether a funds request should be accepted or rejected.

If authorization server 220 determines that the funds request is not authorized (step S.340; No), a rejection message may be generated and provided to third party system 120 (step S.345). The rejection of the funds request may be reported through, for example, communication server 210. In one aspect of the present invention, third party system 120 or provider 140, may provide an indication to user 110 reflecting the denial by provider 140. The indication may be provided using a number of different techniques, including, but not limited to, email, web site postings, telephone messages, page messages, and standard mail notifications. For example, user 110 may receive a message on a web page indicating that the payment request was denied by provider 140.

If, on the other hand, the funds request is authorized (step S. 340; Yes), authorization server 220 may provide an indication of the authorization to the third party system 120. Authorization server 220 may also report the financial account information comprising, for example, payment amount and account identifier, to marketing and analysis server 230. Marketing and analysis server 230 may generate transaction records that reflect the authorization process for each funds request and store the records in a transaction log located in database 240. The transaction logs may be used for auditing and/or feedback purposes by financial account provider 140. In one aspect of the invention, communication server 210 may retrieve the transaction logs from database 240 and make the logs available to third party system 120. For example, communication server 210 may push the transaction logs to third party system 120 or the logs may be retrieved from communication server 210 by third party system 120. Alternatively, other entities, such as user 110 and merchant 130, may access the transaction logs. Further, the transaction logs may be located in a memory device remotely located from provider 140.

In addition to generating records, marketing and analysis server 240 may also provide transaction information associated with the funds request to payment server 250 (step S.350). In one aspect of the invention, payment server 250 may charge the payment amount indicated in the funds request against the financial account associated with user 110. For example, if the payment amount is $200 and an outstanding balance for the account is $1000, payment server 250 may add the $200 to the outstanding balance. Also, payment server 250 may add any transaction fees that financial account provider 140 may have previously determined for processing requests from the third party system 120. Any such fees assessed to the financial account may be lower than the fees that would be passed to user's financial account if a transaction was processed using interchange network 125.

Once the user's financial account is reconciled with the appropriate funds as indicated in the funds request, payment server may generate and provide a payment message to third party system 120 (step S.360). The payment message may be an electronic payment message that allows provider 140 to transfer funds to third party system 120, such as an ACH transfer. The funds may be transferred from the financial account associated with user 110. Alternatively, the funds may be transferred from a financial account not associated with user 110. For example, financial account provider 140 may transfer funds from an account associated with provider 140, such as a corporate account. Alternatively, provider 140 may obtain the funds from another financial source, such as a financial institution remote from provider 140. Additionally, the funds for the payment message may be obtained from a financial account that supplements the user's financial account. For instance, provider 140 may offer user 110 an overdraft protection plan that allows funds to be obtained from a secondary account in the event the user's primary account has insufficient funds to cover a transaction. Accordingly, in the event a primary account does not include sufficient funds to handle the payment amount requested by user 110, provider 140 may retrieve the sufficient funds from a secondary account associated with the user. Alternatively, the secondary account may be associated with provider 140 and if used, a fee may be charged to user 110 for compensating the payment message from the provider's secondary account.

The payment message may be provided from payment server 250 to third party system 120 through communication server 210 or may be provided directly from payment server 250 to third party system 140. Also, the payment message may be provided from provider 140 to third party system 120 using the same communication session established by third party server 120, as described above. Alternatively, provider 140 may establish a new communication session with third party system 120 to provide the payment message. Also, the payment message may be transferred to third party system 120 using network 125 or a direct link established between provider 140 and third party system 120. Further, the funds transferred in the payment message to third party system 140 may be less than, equal to, or greater than the payment amount indicated in the payment request provided by user 110.

Consistent with embodiments of the invention, the techniques used to transfer the funds to third party system 120 from financial account provider 140 may be performed using non-electronic transfer techniques. For example, financial account provider 140 may provide funds to third party server 120 using standard mail infrastructures (e.g., sending a paper check to third party system 120). Further, financial account provider 140 may be configured to provide third party system 120 with a batch file of multiple fund transfers for multiple financial accounts instead of a single fund transfer message. For example, financial account provider 140 may maintain a batch file of pending fund transfers associated with multiple financial accounts and payment requests from one ore more users. Further, the batch file may be provided periodically to third party system 140 (e.g., hourly, daily, monthly, etc.).

Once third party system 120 receives the payment message or appropriate funds from financial account provider 140, it may provide one or more payments to merchant 130 for the account(s) indicated in the payment request provided by user 110 (step S.370). In one aspect of the invention, before a payment is provided to merchant 130, third party system 120 may check to determine whether the amount of the funds received from financial account provider 140 is equal to or greater than the payment amount included in the payment request provided by user 110. If there are insufficient funds, third party system 140 may send a request to financial account provider 140 to request additional funds. Alternatively, or additionally, third party system 140 may notify user 110 that there are insufficient funds for payment to merchant 130 and/or that the transactions may be delayed or cancelled.

If there are sufficient funds in the payment message provided by financial account provider 140, third party system 140 may provide a payment message or funds to merchant 130 for one or more designated accounts associated with user 110. The funds may be provided by third party system 120 using a variety of payment techniques, such as an ACH transfer. Further, the funds provided by third party system 120 may be obtained from a financial account maintained by system 120 or by other entities, such as a financial institution remotely located from system 120. For example, third party system 120 may deposit the funds received from provider 140 into a financial account maintained by a financial institution. Accordingly, when system 120 provides funds to merchant 130, the appropriate amount of funds may be retrieved from the financial institution prior to transferring the payment to merchant 130. Alternatively, third party system 120 may instruct the financial institution to transfer of funds directly to merchant 130.

In accordance with an embodiment of the present invention, third party system 120 may identify the appropriate merchant to provide payment based on the merchant identified in the payment request provided by user 110. Further, third party system 120 may designate a specific account that the funds are to be applied. The designated account may correlate to the account specified in the payment request provided by user 110. Once the funds are received by third party system 120, merchant 130 may apply the payment to the appropriate account associated with user 110. Further, according to an embodiment of the invention, third party system 120 may provide user 110 and/or financial account provider 140 with an indication reflecting that the payment was provided to merchant 130. The indication of the payment may be provided by system 120 using variety of techniques, including email messages, pager messages, web site postings, telephony-based voice messages, etc. For example, system 120 may provide the indication in a web page associated with a web site maintained by system 120. User 110 may access the web page using a browser application to view the indication of payment to merchant 130.

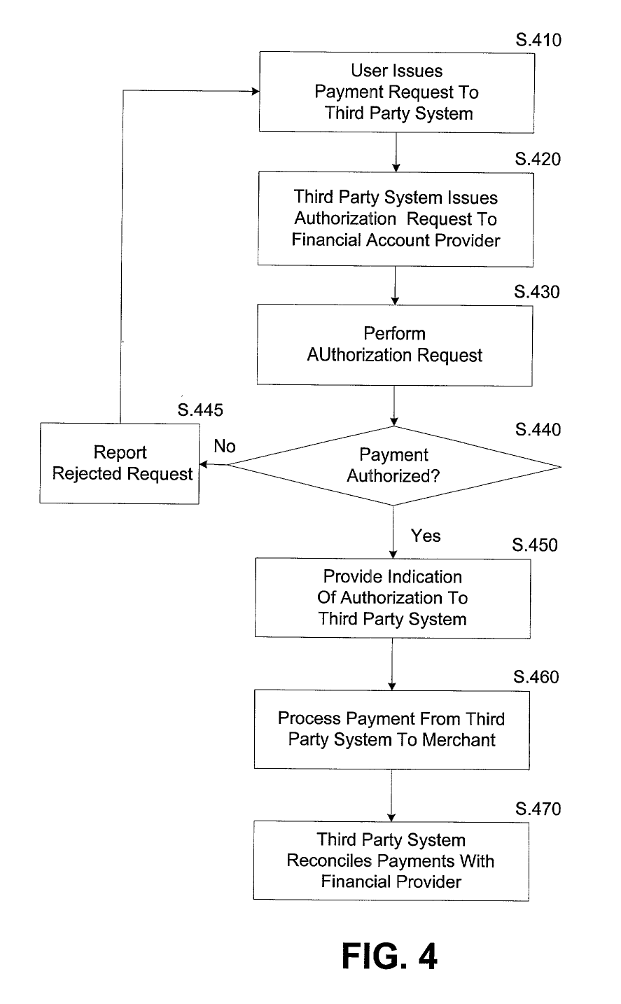

As described, certain embodiments of the present invention enable third party system 120 to obtains funds from provider 140 prior to making a payment to merchant 130 on behalf of user 110. In another embodiment of the present invention, system 120 may provide a payment to merchant 130 on behalf of user 110 prior to obtaining funds from provider 140. FIG. 4 shows a flowchart of an alternate payment process associated with this embodiment of the invention.

As illustrated in FIG. 4, a payment process may begin with user 110 issuing a payment request to third party system 120 (step S.410). The payment request may be similar to the payment request described previously with respect to step S.310 of FIG. 3. Once third party system 120 receives the payment request, it may issue an authorization request to financial account provider 140 (step S.420). The authorization request may be a request to determine whether an account associated with user 110 is in good standing or has a sufficient balance to cover the payment amount included in the payment request. The status of an account may be associated with a number of different criteria, such as account balance, financial transaction history (e.g., late payments, missed payments, over the limit charges, etc.), credit level changes associated with the user, and/or any other type of criteria that provider 140 may determine is appropriate to associate with a financial account. Further, system 120 may collect a number of payment requests from a number of different users and periodically (e.g., hourly, daily, weekly, etc.) provide the authorization request for each user in a batch file.

In response to receiving the authorization request, financial account provider 140 may perform an authorization process (step S.430). The authorization process may be similar to the authorization process described previously with respect to step S.330 of FIG. 3. For example, provider 140 may determine whether the user's account meets predetermined criteria (e.g., whether the account is in good standing or includes sufficient funds to cover the payment amount indicated in the payment request). If provider 140 determines that the user's account does not meet the predetermined criteria associated with the authorization process (step S.440; No), an indication of the rejected authorization request may be provided to third party system 120 (step S.445). If, on the other hand, provider 140 determines that the user's account meets the predetermined criteria (i.e., payment authorized, step S.440; Yes), an indication of the accepted authorization request may be provided to third party system 120 (step S.450). The indications associated with the authorization request (rejected or accepted) may be provided in a number of different mediums and configurations, including an email message, pager message, telephony-based voice mail message, and a information included in a web page that may be accessed by user 110. Further, the indications associated with the authorization request (rejected or accepted) may be provided to user 110 through third party system 120 or directly from provider 120.

Once the authorization indication is received, third party system 120 may process a payment to merchant 130 (step S.460). The payment made to merchant 130 may include a payment message similar to that described previously with respect to step S.360 of FIG. 3. For example, system 120 may obtain funds, from a source account, that equal at least the payment amount indicated in the payment request and provide the funds to merchant 130 using, for an example, and ACH transfer. Further, the source account may be maintained by third party system 120 or by a separate entity, such as a financial institution remotely located from system 120.

After the payment has been made to merchant 130 on behalf of user 110, third party system 120 may reconcile the payment from provider 140 (step S.470). This step may be performed immediately, periodically (e.g., at the end of each day) or after a predetermined time period has lapsed. As part of this step, system 120 may issue a funds request to financial account provider 140 to obtain funds equal to the payment amount made to merchant 130 on behalf of user 110. Thus, if third party system 120 provided $200 to merchant 130 on behalf of user 110, system 120 may request $200 from financial account provider 140. The request from system 120 may also identify the user's financial account maintained by provider 140. Provider 140 may receive the request, obtain the appropriate funds from the user's account, and provide the appropriate funds to system 120 using, for example, an ACH transfer.

In an embodiment of the present invention, system 120 may configure a request for funds from provider 140 as a batch file or request. For example, system 120 may process a number of different payments to one or more different merchants on behalf of one or more different user's 110 (or user accounts). Periodically (e.g., hourly, daily, weekly, monthly, etc.), system 120 may create a batch file including a plurality of funds request associated with the number of different payments made on behalf of the one or more different users. System 120 may then provide the batch file to provider 140 for reconciliation of the funds provided to the one or more different merchants. Alternatively, system 120 may determine an amount that system 120 has paid on the behalf of a plurality of users that have accounts with provider 140 over a previous period of time (e.g., the previous day, week, etc.) and request a single payment of funds from provider 140.

Provider 140 may process each funds request in the batch file and either provide the appropriate funds to system 120. Provider 140 may generate an individual payment message that includes the appropriate funds for each payment made by system 120 on behalf of a user 1 00. Alternatively, provider 140 may create a batch file that includes a plurality of individual payments associated with the payments made by system 120 to the one or more merchants 130. Further, provider 140 may provide a single payment that covers the payments made by system 120 to the one or more merchants 130.

As described, methods, systems, and articles of manufacture consistent with embodiments of the invention not only allow a user to enlist the services of a third party system to make payments to a merchant using a financial account held by the user, but also to allow the payments to be made without the use of an interchange network. Different processes, elements, and architectures may be used other than those described herein without departing from the scope of the present invention. For example, financial account provider 140 may be configured to process transactions from a remote entity other than third party system 120. That is, user 110 may generate a purchase transaction associated with merchant 130 directly. The purchase transaction may include an identifier associated with financial account provider 140. Accordingly, merchant 130 may establish a communication session with third party system 120 or directly with provider 140 that bypasses interchange network 124. Merchant 130 may then provide a funds request to financial account provider 140 that includes an identifier of a user's account held with provider 140. The funds request may be processed by financial account provider 140 such that the payment amount included in the fund request is charged to the user's account. Further, financial account provider 140 may generate a payment message that provides funds to merchant 130 directly to compensate merchant 130 for the transaction with user 110.

Additionally, although FIG. 1 shows a single financial account provider 140, user 110, merchant 130, and third party system 120, any number or combination of these elements may be implemented without departing from the scope of the invention. Further, the configuration of FIG. 1 may be modified without departing from the scope of the invention. For example, the services of third party system 120 may be implemented within a combined system including financial account provider 140. Further, merchant 130 may include a system that performs the same functions as third party system 120. Also, financial account provider 140 may be configured with less or more components than those depicted in FIG. 2, without departing from the scope of the present invention.

Moreover, the above-noted features and other aspects of the embodiments of the present invention may be implemented in various systems or network environments to provide automated priority service for customers. Such environments and applications may be specifically constructed for performing various processes and operations of the embodiments of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques.

Embodiments of the present invention also relate to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

Furthermore, although aspects of the invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents.

Other modifications and embodiments of the invention will be apparent to those skilled in the art from consideration of the specification and practice of the embodiments of the invention disclosed herein. Therefore, it is intended that the specification and examples be considered as exemplary only, with a true scope and spirit of embodiments of the invention being indicated by the following claims.

What is claimed is:

1. A method for making payments on behalf of a customer to a first customer account associated with a merchant using a third party system, the method comprising:
receiving, at the third party system, a first identifier that identifies the merchant and the first customer account, an indication of an amount owed by the customer to the merchant, and a second identifier that identifies a second customer account and an issuer of the second customer account, wherein the second customer account comprises a credit account that is adapted to be used with a financial interchange network to process requests for funds;
providing a communication channel that bypasses the interchange network;
forwarding a request for funds in the amount over the communication channel to the issuer to determine whether the second customer account has sufficient available credit to make a payment in the amount owed to the first customer account;
receiving a response from the issuer over the communication channel indicating approval; and
making payment to the first customer account in accordance with the amount owed to the merchant.

2. The method of claim 1, further comprising:
providing an indication that the amount owed was paid to the first customer account.

3. The method of claim 2, wherein the third party system maintains a web site, and providing an indication comprises:
providing, through the web site, an indication that the amount owed was paid.

4. The method of claim 1, wherein the first identifier, the indication of the amount owed, and the second identifier are provided from the customer through a web site maintained by the third party system.

5. A computer-implemented method for providing financial services that bypasses a financial interchange network, comprising:
providing, from a third party system to a financial account provider, a funds request that identifies a payment amount and merchant designated by a user, and a financial account held by the user with the financial account provider, wherein the third party system bypasses the interchange network to provide the funds request;
authorizing the funds request;
charging the payment amount to the financial account based on the authorization of the funds request; and
transferring funds to the third party system for payment to the merchant, wherein the funds transferred includes at least the payment amount designated by the user.

6. The method of claim 5, wherein authorizing the funds request comprises at least one of:
determining whether the financial account includes sufficient credit to allow the payment amount to be charged to the financial account;
determining whether the financial account is in good standing; and
determining whether the financial account identifier is properly associated with the user.

7. The method of claim 5, further comprising:
providing an indication to the user reflecting payment to the merchant.

8. The method of claim 7, wherein the indication is included in at least one of the following:
an electronic mail message;
data included in a web page;
a pager message; and
a telephony-based voice message.

9. The method of claim 5, wherein the financial account is a credit card account and the payment amount is associated with goods and/or services purchased by the user from the merchant.

10. The method of claim 5, wherein authorizing the funds request further comprises:
providing an indication to the user reflecting that the funds request was not authorized.

11. The method of claim 10, wherein providing the indication comprises:
providing the indication to the user using at least one of the following:
email services
web site message services,
pager messaging services, and
telephony-based voice messaging services.

12. A system for providing payment services that bypasses a financial interchange network, comprising:
a third party system for receiving, from a user, a payment request that includes an identifier of a merchant account associated with the user, a payment amount, and an identifier of a financial account associated with the user; and
a financial account provider adapted to: receive, from the third party system, a funds request including the payment amount and the financial account identifier; authorize the funds request; charge the payment account to the financial account; and transfer funds at least equal to the payment amount to the third party system,
wherein the third party system provides a payment to the merchant equal to the funds transferred from the financial account provider and the third party system and financial account provider exchange information without the services of the interchange network.

13. The system of claim 12, wherein the third party system provides the payment request to the financial account provider using a communication session that bypasses the interchange network.

14. The system of claim 12, wherein the third party system is configured to provide an indication to the user reflecting the status of the authorization of the request.

15. The system of claim 12, wherein the third party system is configured to provide an indication to the user reflecting the payment to the merchant.

16. The system of claim 12, wherein the financial account is associated with a available balance and the financial account provider is configured to authorize the funds request by:
determining whether the available balance of the financial account is exceeded if the payment amount is charged to the financial account.

17. The system of claim 12, wherein the financial account provider is configured to authorize the funds request by:
determining whether the financial account is in good standing.

18. The system of claim 12, wherein the financial account provider electronically transfers the funds to the third party system.

19. The system of claim 12, wherein the third party system electronically transfers the payment to the merchant.

20. The system of claim 12, wherein the merchant applies the payment provided by the third party system to the merchant account.

21. The system of claim 12, wherein the user is not charged fees associated with services provided by the interchange network.

22. A computer-implemented method for providing financial services that bypasses a financial interchange network, comprising:
providing, from a third party system to a financial account provider, an authorization request that identifies a payment amount associated with a merchant and a financial account held by the user with the financial account provider, wherein the third party system bypasses the interchange network to provide the authorization request;
providing a payment from the third party system to the merchant based on an authorization of the authorization request by the financial account provider;
providing, from the third party system to the financial account provider, a request for funds equal to the payment provided by the third party system to the merchant; and
providing the funds from the financial account provider to the third party system.

23. A method for receiving financial services from a third party system that bypasses a financial interchange network, comprising:
providing a payment request to the third party system that includes a financial account identifier, a merchant identifier, and a payment amount due to the merchant based on a transaction with the merchant; and
receiving an indication that the third party system provided payment to the merchant equal to the payment amount,
wherein the third party system bypasses an interchange network to provide the payment to the merchant and further wherein the payment is provided based on funds received from a financial account provider that maintains the financial account identified in the payment request.

24. The method of claim 23, wherein receiving an indication comprises:
receiving an indication that the third party system provided a payment to the merchant equal to the payment amount, wherein the third party system bypassed an interchange network to provide the payment to the merchant and the payment was provided based on funds charged to the financial account identified in the payment request by a financial account provider that maintains the financial account.

25. The method of claim 23, wherein payment by the third party system is provided to the merchant based on the merchant identifier included in the payment request.

26. The method of claim 23, wherein the indication is received in at least one of the following:
an electronic mail message;
data included in a web page;
a pager message; and
a telephony-based voice message.

27. The method of claim 23, wherein payment is provided based on an authorization of a request for funds provided from the third party system to a financial account provider that maintains the financial account identified in the payment request.

28. The method of claim 27, wherein the authorization of the request for funds is performed by the financial account provider.

29. The method of claim 27, wherein the request for funds includes the financial account identifier and the payment amount.

30. A computer-readable medium including instructions for performing a method, when executed by a processor, for providing financial services that bypasses a financial interchange network, the method comprising:
providing, from a third party system to a financial account provider, a funds request that identifies a payment amount and merchant designated by a user, and a financial account held by the user with the financial account provider, wherein the third party system bypasses the interchange network to provide the funds request;
authorizing the funds request;
charging the payment amount to the financial account based on the authorization of the funds request; and
transferring funds to the third party system for payment to the merchant, wherein the funds transferred includes at least the payment amount designated by the user.

31. The computer-readable medium of claim 30, wherein authorizing the funds request comprises at least one of:
determining whether the financial account includes sufficient credit to allow the payment amount to be charged to the financial account;
determining whether the financial account is in good standing; and
determining whether the financial account identifier is properly associated with the user.

32. The computer-readable medium of claim 30, wherein the method further comprises:
providing an indication to the user reflecting payment to the merchant.

33. The computer-readable medium of claim 32, wherein the indication is included in at least one of the following: an electronic mail message;
data included in a web page;
a pager message; and
a telephony-based voice message.

34. The computer-readable medium of claim 30, wherein the financial account is a credit card account and the payment amount is associated with goods and/or services purchased by the user from the merchant.

35. The computer-readable medium of claim 30, wherein authorizing the funds request further comprises:
providing an indication to the user reflecting that the funds request was not authorized.

36. The computer-readable medium of claim 35, wherein providing the indication comprises:
providing the indication to the user using at least one of the following:
email services
web site message services,
pager messaging services, and
telephony-based voice messaging services.

37. A computer-readable medium including instructions for performing a method, when executed by a processor, for providing financial services that bypasses a financial interchange network, the method comprising:
providing, from a third party system to a financial account provider, an authorization request that identifies a payment amount associated with a merchant and a financial account held by the user with the financial account provider, wherein the third party system bypasses the interchange network to provide the authorization request;
providing a payment from the third party system to the merchant based on an authorization of the authorization request by the financial account provider;
providing, from the third party system to the financial account provider, a request for funds equal to the payment provided by the third party system to the merchant; and
providing the funds from the financial account provider to the third party system.

38. A computer-readable medium including instructions for performing a method, when executed by a processor, for receiving financial services from a third party system that bypasses a financial interchange network, the method comprising:
providing a payment request to the third party system that includes a financial account identifier, a merchant identifier, and a payment amount due to the merchant based on a transaction with the merchant; and
receiving an indication that the third party system provided payment to the merchant equal to the payment amount,
wherein the third party system bypasses an interchange network to provide the payment to the merchant and further wherein the payment is provided based on funds received from a financial account provider that maintains the financial account identified in the payment request.

39. The computer-readable medium of claim 38, wherein receiving an indication comprises:
receiving an indication that the third party system provided a payment to the merchant equal to the payment amount, wherein the third party system bypassed an interchange network to provide the payment to the merchant and the payment was provided based on funds charged to the financial account identified in the payment request by a financial account provider that maintains the financial account.

40. The computer-readable medium of claim 38, wherein payment by the third party system is provided to the merchant based on the merchant identifier included in the payment request.

41. The computer-readable medium of claim 38, wherein the indication is received in at least one of the following:
an electronic mail message;
data included in a web page;
a pager message; and
a telephony-based voice message.

42. The computer-readable medium of claim 38, wherein payment is provided based on an authorization of a request for funds provided from the third party system to a financial account provider that maintains the financial account identified in the payment request.

43. The computer-readable medium of claim 42, wherein the authorization of the request for funds is performed by the financial account provider.

44. The computer-readable medium of claim 42, wherein the request for funds includes the financial account identifier and the payment amount.

45. A system for providing financial services that bypasses a financial interchange network, comprising:
means for providing, from a third party system to a financial account provider, a funds request that identifies a payment amount and merchant designated by a user, and a financial account held by the user with the financial account provider, wherein the third party system bypasses the interchange network to provide the funds request;
means for authorizing the funds request;
means for charging the payment amount to the financial account based on the authorization of the funds request; and
means for transferring funds to the third party system for payment to the merchant, wherein the funds transferred includes at least the payment amount designated by the user.

46. The system of claim 45, wherein the means for authorizing the funds request comprises at least one of:
means for determining whether the financial account includes sufficient credit to allow the payment amount to be charged to the financial account;
means for determining whether the financial account is in good standing; and
means for determining whether the financial account identifier is properly associated with the user.

47. The system of claim 45, further comprising:
means for providing an indication to the user reflecting payment to the merchant.

48. The system of claim 47, wherein the indication is included in at least one of the following:
an electronic mail message;
data included in a web page;
a pager message; and
a telephony-based voice message.

49. The system of claim 45, wherein the financial account is a credit card account and the payment amount is associated with goods and/or services purchased by the user from the merchant.

50. The system of claim 45, wherein the means for authorizing the funds request further comprises:
means for providing an indication to the user reflecting that the funds request was not authorized.

51. The system of claim 50, wherein the means for providing the indication comprises:
means for providing the indication to the user using at least one of the following:
email services
web site message services,
pager messaging services, and
telephony-based voice messaging services.

52. A system for providing financial services that bypasses a financial interchange network, comprising:
means for providing, from a third party system to a financial account provider, an authorization request that identifies a payment amount associated with a merchant and a financial account held by the user with the financial account provider, wherein the third party system bypasses the interchange network to provide the authorization request;
means for providing a payment from the third party system to the merchant based on an authorization of the authorization request by the financial account provider;
means for providing, from the third party system to the financial account provider, a request for funds equal to the payment provided by the third party system to the merchant; and
means for providing the funds from the financial account provider to the third party system.

53. A system for receiving financial services from a third party system that bypasses a financial interchange network, comprising:
means for providing a payment request to the third party system that includes a financial account identifier, a merchant identifier, and a payment amount due to the merchant based on a transaction with the merchant; and
means for receiving an indication that the third party system provided payment to the merchant equal to the payment amount,
wherein the third party system bypasses an interchange network to provide the payment to the merchant and further wherein the payment is provided based on funds received from a financial account provider that maintains the financial account identified in the payment request.

54. The system of claim 53, wherein the means for receiving an indication comprises:
means for receiving an indication that the third party system provided a payment to the merchant equal to the payment amount, wherein the third party system bypassed an interchange network to provide the payment to the merchant and the payment was provided based on funds charged to the financial account identified in the payment request by a financial account provider that maintains the financial account.

55. The system of claim 53, wherein payment by the third party system is provided to the merchant based on the merchant identifier included in the payment request.

56. The system of claim 53, wherein the indication is received in at least one of the following:
an electronic mail message;
data included in a web page;
a pager message; and
a telephony-based voice message.

57. The system of claim 53, wherein payment is provided based on an authorization of a request for funds provided from the third party system to a financial account provider that maintains the financial account identified in the payment request.

58. The system of claim 57, wherein the authorization of the request for funds is performed by the financial account provider.

59. The system of claim 57, wherein the request for funds includes the financial account identifier and the payment amount.
